(19) United States
(12) Patent Application Publication
(10) Pub. No.: US 2016/0180996 A1
(43) Pub. Date: Jun. 23, 2016

(54) SUPERCONDUCTING MAGNET SYSTEM

(71) Applicant: General Electric Company, Schenectady, NY (US)

(72) Inventors: Anbo Wu, Shanghai (CN); Evangelos Trifon Laskaris, Niskayuna, NY (US); Paul St. Mark Shadforth Thompson, Niskayuna, NY (US); Tao Zhang, Niskayuna, NY (US); Qi Zhao, Niskayuna, NY (US); GuangZhou Li, Shanghai (CN)

(73) Assignee: General Electric Company, Schenectady, NY (US)

(21) Appl. No.: 14/060,981

(22) Filed: Oct. 23, 2013

(30) Foreign Application Priority Data
Nov. 12, 2012 (CN) 201210451262.0

(51) Int. Cl. H01F 6/06; H01F 6/04

(52) U.S. Cl. CPC H01F 6/06; H01F 6/04

(57) ABSTRACT

A superconducting magnet system including a coil former, superconducting coils supported by the coil former, and one or more thermally conductive tubes. The one or more thermally conductive tubes are embedded inside of the coil former. The one or more thermally conductive tubes are in thermal contact with the coil former and arranged to receive a cryogen.

### BACKGROUND

Embodiments of the present invention relate to a superconducting magnet system.

Superconducting magnet systems having relatively large energies are currently used in many applications. For example, superconducting magnet systems, storing energies of up to 15M Joules, are constructed for Magnetic Resonance Imaging (MRI) systems which are now routinely used in large numbers in clinical environments for medical imaging. A part of such an MRI system is a superconducting magnet system for generating a uniform magnetic field. The superconducting magnet systems also can be utilized in other systems, such as nuclear magnetic resonance (NMR) systems, accelerators, transformers, generators, motors, superconducting magnet energy storages (SMES) and so on.

Superconducting magnets conduct electricity without resistance as long as maintained at a suitably low temperature, which is referred to as “superconducting temperature” hereinafter. Accordingly, cryogenic systems are used to ensure that the superconducting magnets work at the superconducting temperature. Heat transfer efficiency is very important for superconducting magnets. A conventional thermosiphon cryogenic system includes cooling tubes in thermal contact with an outer surface of a coil former which supports superconducting coils. The cooling tubes receive cryogen, such as liquid helium, passing therethrough for cooling the superconducting magnets to maintain the superconducting magnets at the superconducting temperature for superconducting operations. The cryogen heat exchanges with the coil former via the surface of the cooling tubes in contact with the outer surface of the coil former. The cooling tubes assembled on the outer surface of the coil former have low heat transfer efficiency, which sometimes do not provide effective cooling of the superconducting magnets.

### BRIEF DESCRIPTION

According to embodiments of the present invention, there is provide a superconducting magnet system. The superconducting magnet system includes a coil former, superconducting coils supported by the coil former, and one or more thermally conductive tubes. The thermally conductive tubes are embedded inside of the coil former. The thermally conductive tubes are in thermal contact with the coil former and are arranged to receive a cryogen.

According to an embodiment of the present invention, there is provided a superconducting magnet system. The superconducting magnet system comprising a vacuum vessel forming a central magnetic field area, a thermal shield arranged concentrically within the vacuum vessel; a coil former arranged concentrically in the thermal shield; superconducting coils supported by the coil former, and one or more thermally conductive tubes embedded inside of the coil former, the one or more thermally conductive tubes being in thermal contact with the coil former and arranged to receive a cryogen.

### DRAWINGS

These and other features and aspects of embodiments of the present invention will become better understood when the following detailed description is read with reference to the accompanying drawings in which like characters represent like parts throughout the drawings, wherein:

FIG. 1 is a schematic cross-sectional view taken along a vertical center line of a superconducting magnet system according to an embodiment;

FIG. 2 is a schematic cross-sectional view taken along a vertical center line of the superconducting magnet system according to an embodiment;

FIG. 3 is a schematic view of a cooling circuit of the superconducting magnet system according to an embodiment;

FIG. 4 is a perspective view of a coil former of the superconducting magnet system and thermally conductive tubes therein according to an embodiment;

FIG. 5 is a sectional view of the coil former taken along line 4-4 of FIG. 4;

FIG. 6 is a sectional view of the thermally conductive tubes according to an embodiment; and

FIG. 7 is a partially cutaway view of the coil former and the thermally conductive tubes therein according to an embodiment.

### DETAILED DESCRIPTION

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items, and terms such as “front”, “back”, “bottom”, and/or “top”, unless otherwise noted, are merely used for convenience of description, and are not limited to any one position or spatial orientation. Moreover, the terms “coupled” and “connected” are not intended to distinguish between a direct or indirect coupling/connection between two components. Rather, such components may be directly or indirectly coupled/connected unless otherwise indicated.

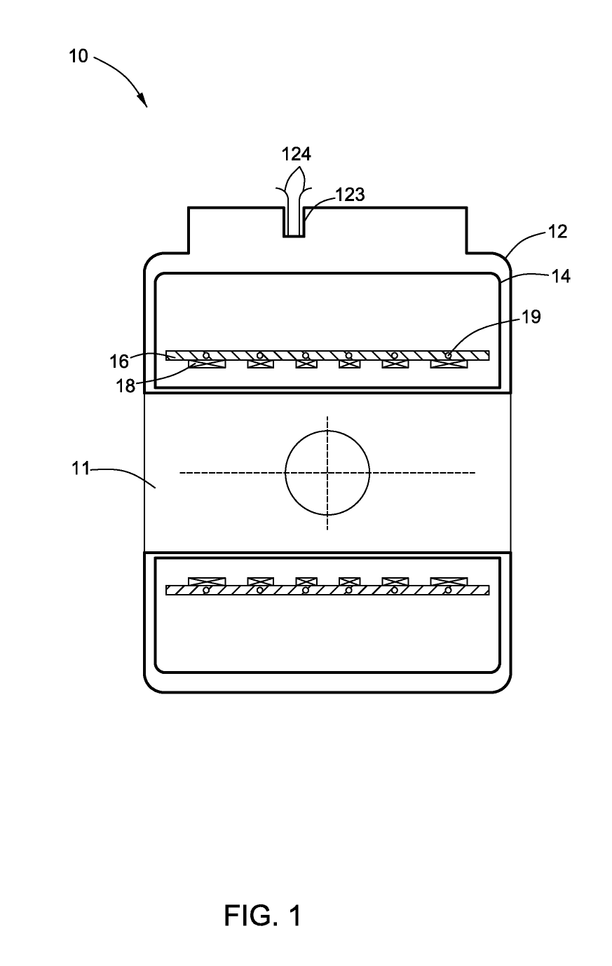

FIG. 1 illustrates a schematic cross-sectional view taken along a vertical center line of a superconducting magnet system 10 according to an embodiment. The superconducting magnet system 10 can be used in many suitable fields, such as a magnetic resonance imaging (MRI) system, a nuclear magnetic resonance (NMR) system, an accelerator, a transformer, a generator, a motor, a superconducting magnet energy storage (SMES) and so on. The superconducting magnet system 10 includes a vacuum vessel 12 forming a central magnetic field area 11, a thermal shield 14 arranged concentrically within the vacuum vessel 12, a coil former 16 arranged concentrically in the thermal shield 14, a number of superconducting coils 18 supported by the coil former 16, and one or more thermally conductive tubes 19 embedded inside of the coil former 16. The vacuum vessel 12, the thermal shield 14 and the coil former 16 have cylindrical shape. Other shapes are possible for each of the vacuum vessel 12, the thermal shield 14 and the coil former 16.

The vacuum vessel 12 includes a service port 123 providing communicating ports having multiple power leads 124 used to electrically couple external power to the superconducting coils 18 and other electrical parts (not shown). In this embodiment, the superconducting coils 18 are wound or assembled and attached on an inner surface of the coil former 16. in some embodiments, the superconducting coils 18 may be wound or assembled on an outer surface of the coil former 16.

The thermally conductive tubes 19 are in thermal contact with the coil former 16. The thermally conductive tubes 19 are arranged to receive a cryogen (not shown) passed therethrough to cool the coil former 16. The cryogen may be liquid helium, liquid hydrogen, liquid nitrogen, liquid neon, and the like. The cryogen is chosen to have a temperature lower than the superconductor critical temperature required by the combination of current density and magnetic field at which the superconductor will be operating.

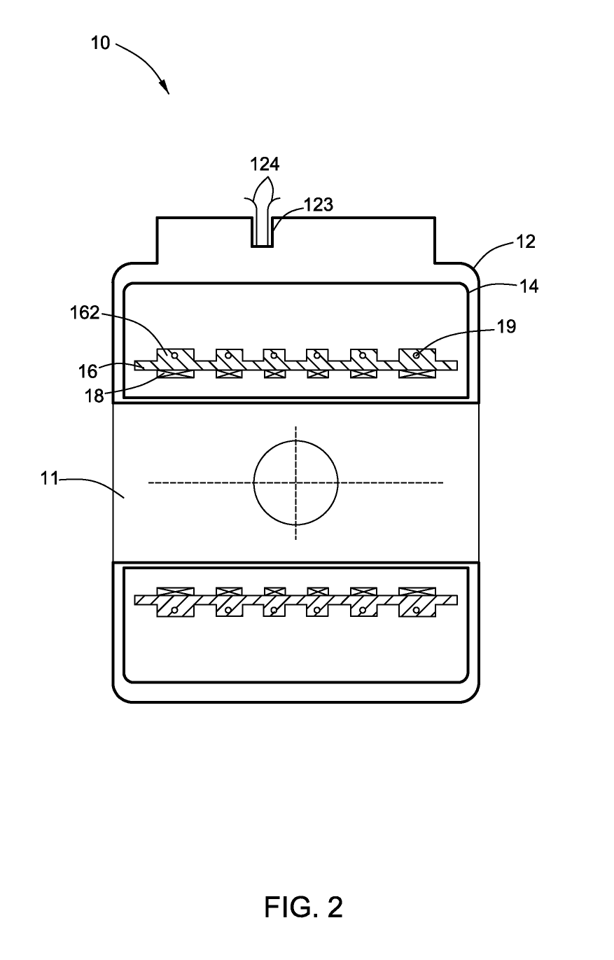

FIG. 2 illustrates a schematic cross-sectional view taken along a vertical center line of the superconducting magnet system 10 according to an embodiment. Compared with the embodiment of FIG. 1, the coil former 16 includes one or more protrusions 162 in which the thermally conductive tubes 19 are embedded. The construction of this embodiment can increase the stiffness of the coil former 16 compared with the above embodiments.

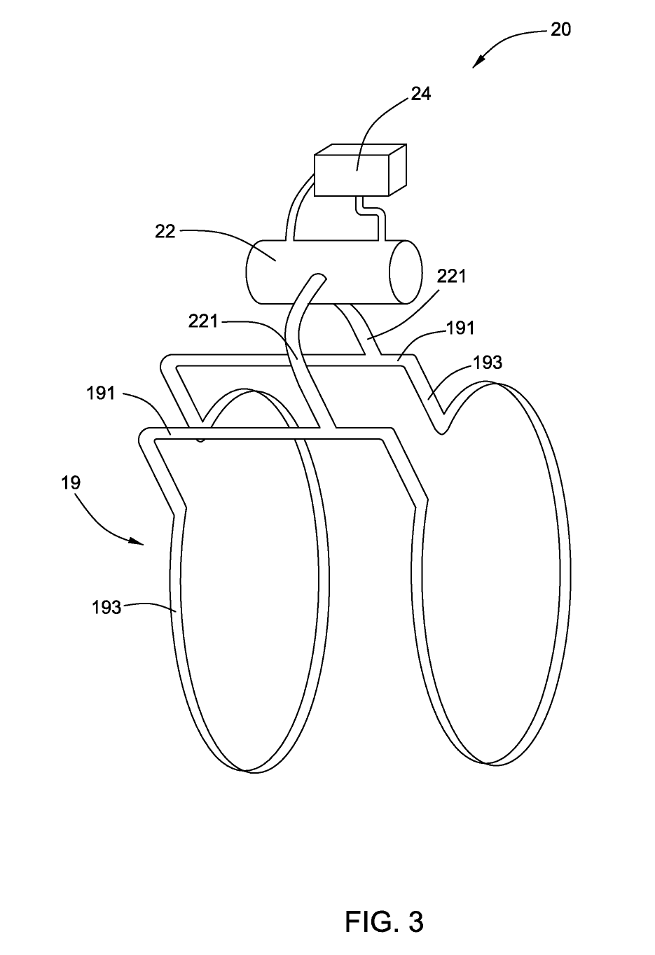

FIG. 3 illustrates a schematic view of a cooling circuit 20 of the superconducting magnet system 10 according to an embodiment. The cooling circuit 20 includes the thermally conductive tubes 19, a cryogen container 22 and a refrigerator 24. The cryogen container 22 is connected with the thermally conductive tubes 19 and configured to contain the cryogen. In the illustrated embodiment, the cryogen container 22 includes two pipes 221 connected with the thermally conductive tubes 19 to circulate the cryogen in the thermally conductive tubes 19 and the cryogen container 22. In some embodiments, two cryogen containers 22 are provided in the cooling circuit 20, which are respectively connected with the thermally conductive tubes 19. In some embodiments, the cryogen container 22 may be made of metal material, such as stainless steel and the like. In some embodiment, the cryogen container 22 is disposed within the thermal shield 14. The refrigerator 24, in this embodiment, is connected to the cryogen container 22 to provide cooling to the cryogen in the cryogen container 22. In an embodiment, the refrigerator 24 may be connected with the thermally conductive tubes 19 to cool the cryogen through the thermally conductive tubes 19. In some embodiments, the refrigerator 24 is disposed outside of the vacuum vessel 12.

In this embodiment shown in FIG. 3, the thermally conductive tubes 19 includes one or more main tubes 191 and a number of branching tubes 193 connected in parallel to the main tubes 191. The main tubes 191 are connected with the cryogen container 22 to pass the cryogen between the cryogen container 22 and the branching tubes 193. The branching tubes 193 may be wrapped substantially around the coil former 16 to pass the cryogen about the coil former 16. The cryogen may be dispersed into the branching tubes 193 via one of the main tubes 191 and flow back into the cryogen container 22 via another of the main tubes 191 so as to increase the heat transfer efficiency. In an embodiment, any other forms of the thermally conductive tubes 19 may be provided in the cooling circuit 20. For example, the branching tubes 193 may be connected with each other in series.

In an embodiment, the thermally conductive tubes 19 are joined to the cryogen container 22 by welding. In order to effectively weld the thermally conductive tubes 19 and the cryogen container 22, the thermally conductive tubes 19 include a same material as the material of the cryogen container 22. For example, the thermally conductive tubes 19 and the cryogen container 22 can be made of the stainless steel. Other materials are possible for the thermally conductive tubes 19 and the cryogen container 22, such as copper and brass. The thermally conductive tubes 19 and the cryogen container 22 may he joined with each other by any other suitable method.

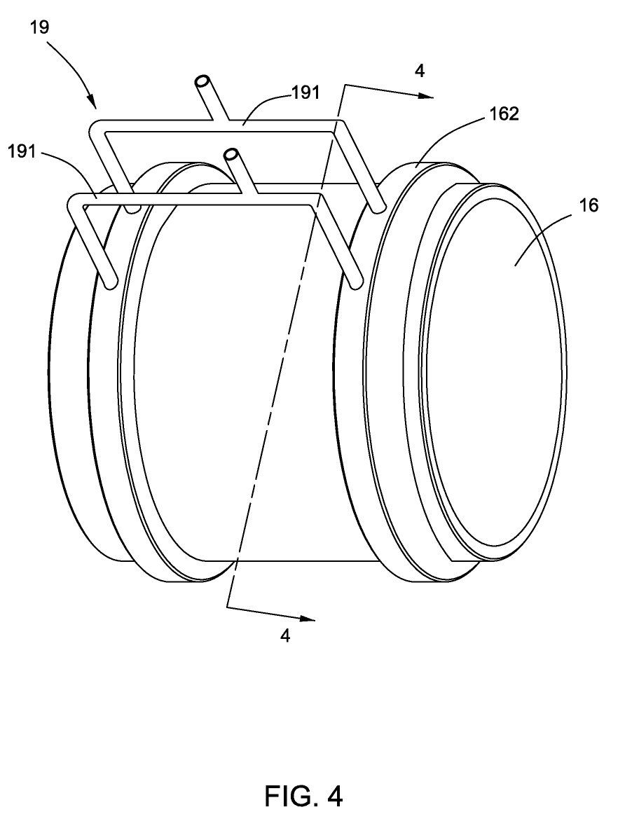

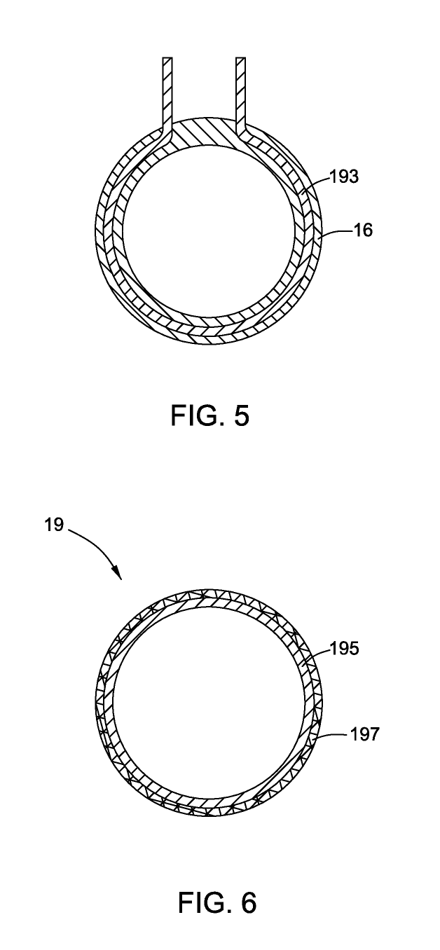

FIG. 4 illustrates a perspective view of the coil former 16 and the thermally conductive tubes 19 therein according to an embodiment. FIG. 5 illustrates a sectional view of the coil former 16 taken along line 4-4 of FIG. 4. Referring to FIGS. 4 and 5, the thermally conductive tubes 19 are embedded inside of the coil former 16 so that full contact between the thermally conductive tubes 19 and the coil former 16 are obtained to raise the heat transfer efficiency. In the illustrated embodiment, the branching tubes 193 of the thermally conductive tubes 19 are embedded inside of the coil former 16 and each surround the coil former 16. In this embodiment, the branching tubes 193 are embedded inside of the protrusions 162 and the main tubes 191 are positioned outside of the coil former 16.

The thermally conductive tubes 19 are made of thermally conductive and non-magnetic material. The coil former 16 is made of thermally conductive material, which, in this embodiment, includes a metal material, such as aluminum, aluminum alloy, and the like. In some embodiments, the thermally conductive tubes 19 can be casted into the coil former 16 by gravity casting or low pressure casting processes so that the process of manufacturing the coil former 16 with the thermally conductive tubes 19 therein is simple and close contact therebetween is obtained. The thermally conductive tubes 19 include a material having a higher melting point than the material of the coil former 16 so that the thermally conductive tubes 19 can be casted in the coil former 16. For example, while the coil former 16 is made of aluminum, the material of the thermally conductive tubes 19 may be copper, stainless steel, brass or any other thermally conductive and non-magnetic material with higher melting point than aluminum. Other material is possible for the coil former 16 and the thermally conductive tubes 19.

In one embodiment, the thermally conductive tubes 19 are in physical contact with the coil former 16. The material of the thermally conductive tubes 19 also has a higher melting point than the material of the coil former 16. And the material of the thermally conductive tubes 19 does not react with the material of the coil former 16 during the casting process so that the thermally conductive tubes 19 may not loss any material, thus the thermally conductive tubes 19 may not be soften and may be maintained in ideal position and size. For example, while the material of the coil former 16 is aluminum, the material of the thermally conductive tubes 19 is stainless steel or any other material having the above-mentioned features thereof. Other material having the above-mentioned features is possible for the coil former 16 and the thermally conductive tubes 19.

FIG. 6 illustrates a sectional view of the thermally conductive tubes 19 according to an embodiment. In this embodiment, the thermally conductive tubes 19 include an inner layer 195 and an outer layer 197. The outer layer 197 is in physical contact with the inner layer 195. The material of the outer layer 197 has a larger thermal expansion coefficient than the material of the inner layer 195, so that the outer layer 197 may contract more than the inner layer 195 at a low temperature at which the superconductor operates. Thus, the outer layer 197 may wrap around the inner layer 195 tightly. Melting points of the inner layer 195 and the outer layer 197 are also higher than that of the coil former 16, and the material of the inner layer 195 has a higher melting point than the material of the outer layer 197.

The outer layer 197 is metallurgically bonded with the coil former 16. The material of the outer layer 197 is a material that is capable of reacting with the melting material of the coil. former 16 during the casting process. At least some of the material of the outer layer 197 reacts with the melting material of the coil former 16 during the casting process to form an alloy layer between the thermally conductive tubes 19 and the coil former 16, so that the thermally conductive tubes 19 and the coil former 16 are bonded tightly together and thermal resistance therebetween is low to facilitate cooling. The material of the inner layer 195 may not react with the melting material of the coil former 16 during the casting process so as to make sure that the thermally conductive tubes 19 are free from fractures. For example, while the material of the coil former 16 is aluminum, the material of the inner layer 195 is stainless steel or any other material having the above-mentioned features thereof, and the material of the outer layer 197 is copper, brass or any other material having the above-mentioned features thereof. Other material having the above-mentioned features may also be utilized for the coil former 16, the inner layer 195 and the outer layer 197.

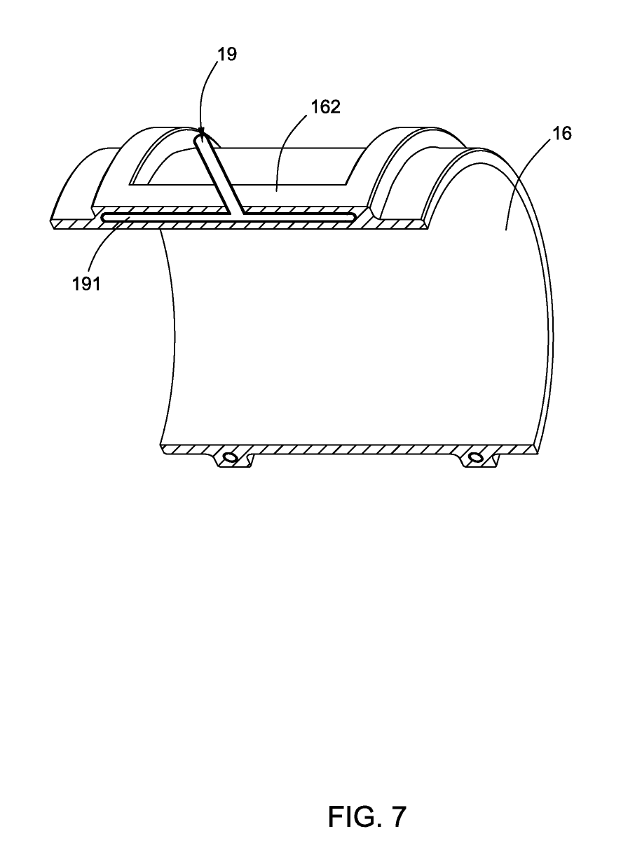

FIG. 7 illustrates a partially cutaway view of the coil former 16 and the thermally conductive tubes 19 therein according to an embodiment. Compared with the embodiment of FIGS. 4 and 5, the main tubes 191, in this embodiment, are embedded inside of the coil former 16 so that the cryogen through the main tubes 191 may also cool the coil former 16. In the illustrated embodiment, the main tubes 191 are embedded inside of the protrusion 162 so as to increase the stiffness of the coil former 16.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A superconducting magnet system, comprising:
a coil former;
superconducting coils supported by the coil former; and
one or more thermally conductive tubes embedded inside of the coil former, the one or more thermally conductive tubes being in thermal contact with the coil former and arranged to receive a cryogen.

2. The superconducting magnet system of claim 1, wherein the one or more thermally conductive tubes comprise a material having a higher melting point than a melting point of a material of the coil former.

3. The superconducting magnet system of claim I, wherein the one or more thermally conductive tubes are in physical contact with the coil former.

4. The superconducting magnet system of claim 1, wherein the one or more thermally conductive tubes comprise an inner layer and an outer layer, the outer layer being in physical contact with the inner layer and metallurgically bonded with the coil former.

5. The superconducting magnet system of claim 4, wherein a material of the inner layer has a higher melting point than a melting point of a material of the outer layer.

6. The superconducting magnet system of claim 4, wherein a material of the outer layer has a larger thermal expansion coefficient than a thermal expansion coefficient of a material of the inner layer.

7. The superconducting magnet system of claim 4, wherein the material of the coil former comprises aluminum, a material of the inner layer comprises stainless steel, and a material of the outer layer comprises copper or brass.

8. The superconducting magnet system of claim 1, wherein the coil former comprises one or more protrusions in which the one or more thermally conductive tubes are embedded.

9. The superconducting magnet system of claim 1, further comprising a cryogen container connected to the one or more thermally conductive tubes and configured to contain the cryogen, wherein the one or more thermally conductive tubes comprise a same material as a material of the cryogen container.

10. The superconducting magnet system of claim 1, wherein the one or more thermally conductive tubes comprise one or more main tubes and a plurality of branching tubes connected in parallel to the one or more main tubes, the plurality of branching tubes being embedded inside of the coil former.

11. The superconducting magnet system of claim 10, wherein the one or more main tubes are embedded inside of the coil former.

12. A superconducting magnet system, comprising:
a vacuum vessel forming a central magnetic field area;
a thermal shield arranged concentrically within the vacuum vessel;
a coil former arranged concentrically in the thermal shield;
superconducting coils supported by the coil former; and
one or more thermally conductive tubes embedded inside of the coil former, the one or more thermally conductive tubes being in thermal contact with the coil former and arranged to receive a cryogen.

13. The superconducting magnet system of claim 12, wherein the one or more thermally conductive tubes comprise a material having a higher melting point than a melting point of a material of the coil former.

14. The superconducting magnet system of claim 12, wherein the one or more thermally conductive tubes is in physical contact with the coil former.

15. The superconducting magnet system of claim 12, wherein the one or more thermally conductive tubes comprise an inner layer and an outer layer, the outer layer being physical contact with the inner layer and metallurgically bonded with the coil former.

16. The superconducting magnet system of claim 15, wherein a material of the inner layer has a higher melting point than a melting point of a material of the outer layer.

17. The superconducting magnet system of claim 15, wherein a material of the outer layer has a larger thermal expansion coefficient than a thermal expansion coefficient of a material of the inner layer.

18. The superconducting magnet system of claim 15, wherein the material of the coil former comprises aluminum, a material of the inner layer comprises stainless steel, and a material of the outer layer comprises copper or brass.

19. The superconducting magnet system of claim 12, wherein the coil former comprises one or more protrusions in which the one or more thermally conductive tubes are embedded.

20. The superconducting magnet system of claim 12, further comprising a cryogen container connected to the one or more thermally conductive tubes and configured to contain the cryogen, wherein the one or more thermally conductive tubes comprise a same material as a material of the cryogen container.
